(19) United States
(12) Patent Application Publication
(10) Pub. No.: US 2007/0025298 A1
(43) Pub. Date: Feb. 1, 2007

(54) Method and system for providing roaming service in mobile communication system

(75) Inventor: Je-Hyun Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/495,630

(22) Filed: Jul. 31, 2006

(30) Foreign Application Priority Data
Aug. 1, 2005 (KR) 2005-70450

(51) Int. Cl. H04Q 7/00

(52) U.S. Cl. 370/331; 455/432.1

(57) ABSTRACT

A method and system for a roaming service in a mobile communication system are provided. The system includes an access terminal for transmitting an NAI (network access identifier) to a packet data serving node of the visited network and an AAA (authentication authorization accounting) of the home network, for transmitting subscriber profile information of the access terminal to the visited network. The packet data serving node of the visited network determines whether or not the access terminal subscribes to the roaming service on the basis of the NAI, and, when it is determined that the access terminal subscribes to the roaming service, sends a request for transmitting the subscriber profile information of the access terminal to the AAA of the home network. The packet data serving node of the visited network also provides at least one data service that the home network has provided to the subscriber, using the subscriber profile information.

### CROSS-REFERENCE TO RELATED APPLICATIONS

This application claims the benefit under 35 U.S.C. § 119(a) of Korean Patent Application Serial No. 2005-70450, filed in the Korean Intellectual Property Office on Aug. 1, 2005, the entire disclosure of which is hereby incorporated by reference.

### BACKGROUND OF THE INVENTION

1. Field of the Invention

The present invention relates generally to a method and system for transmitting a data packet in a wireless communication system. In particular, the present invention relates to a method and system for providing a roaming service between different mobile service providers, and transmitting a data packet.

2. Description of the Related Art

In general, a wireless communication system refers to a system that has been developed for communication between terminals where a fixed wire network is not used for connecting to a terminal. The wireless communication system can typically be a mobile communication system, a wireless local area network (WLAN), a Wireless broadband (Wibro), and a mobile Ad Hoc system.

One purpose of a mobile communication system is to make communication possible even while a subscriber moves at a high speed over a wide area. A typical mobile communication system is a cellular system. The cellular system is based on a concept proposed to overcome the limited service boundary and the limited subscriber capacity of a conventional mobile communication system. The cellular system refers to a system in which the service boundary is divided into several small zones, that is, cells, and two cells sufficiently distant from each other use the same frequency band, thereby allowing the spatial reuse of frequency. One of the first technologies to appear in the cellular system is an analog type such as advance mobile phone system (AMPS) and total access communication services (TACS). This is called “first-generation mobile communication”. A drawback of the first-generation mobile communication system has been its difficulty accepting the rapidly increasing number of mobile service subscribers. Also, the development of technology has increased users' requirements for various services as well as an existing voice service. In response to such requirements, a digital type second-generation mobile communication system more advanced than the first-generation mobile communication system has appeared. Unlike an analog system, the second-generation mobile communication system digitalizes an analog voice signal, performs voice encoding, performs digital modulation, and executes a communication using a frequency band of about 800 MHz. A multiple access method is employed such as a time division multiple access method and a code division multiple access method.

The second-generation mobile communication system provides a voice service and a low-speed data service, and employs IS-95 (CDMA method) and IS-54 (TDMA method) in the U.S., and Global System for Mobile communication (GSM) method in Europe. A personal communication services (PCS) system is classified as a 2.5-generation mobile communication system, and uses a frequency band of about 1.8 to 2 GHz. The second-generation mobile communication system is built for the purpose of providing voice service to the users while increasing an efficiency of the mobile communication system. However, with the advent of Internet and users' requirements for high-speed data service, the advent of a new wireless platform is expected. Such a type is a third-generation mobile communication such as international mobile telecommunication-2000 (IMT-2000).

The CDMA method, a synchronous method for third-generation mobile communication, will be described below.

A CDMA2000 1x service refers to a wireless Internet service based on a maximum speed of 144 Kbps, which is greater than a speed of 14.4 Kbps or 56 Kbps, which has been supported by a conventional IS-95 A/B network. The CDMA2000 1x uses an IS-95C network which is advanced from the conventional IS-95A and IS-95B networks. Thus, it is possible to not only improve qualities of conventional voice and WAP services but also to provide a variety of multimedia services (AOD, VOD), using the CDMA 2000 1x service. The IS-95A and IS-95B are names of an access network. The IS-95B network provides a wireless data communication rate of up to 64 Kbps. The IS-95C, which is a CDMA 2000 1x network, provides a maximum speed of 144 Kbps. Thus, even a portable phone based on the CDMA 2000 1x depends on a local network and accesses the IS-95B or IS-95A if its boundary does not have the IS-95C network installed therein.

Despite the development of such a mobile communication technology, users desire a higher quality of data service. A technology for higher quality data is a CDMA 2000 1x EVolution (EV)—Data Only (DO). The CDMA 2000 1x EV-DO, a protocol only for packet data transmission completely different from a conventional IS-2000 wireless protocol, is a method in which a maximal transfer rate of up to 2.4 Mbps in forward direction is possible. This requires an access network transmission system (ANTS) device separately from an IS-2000 ANTS device, but commonly uses other system and network constituent elements.

In view of a characteristic of packet data, a system-to-terminal service predominates. Thus, the CDMA 2000 1x EV-DO has a structure in which channel speeds of forward and reverse directions are different. The CDMA 2000 1x EV-DO has a structure of an asymmetric data transfer rate of 2.4 Mbps possible in the forward direction and 153.6 Kbps possible in the reverse direction in case where the terminal does not use space diversity.

In IS-2000, in principle, high-speed packet data is embodied in a voice-centered protocol and thus, a maximum transfer rate has a limit. In IS-2000 release 0, packet data can be transmitted at a transfer rate of up to 153.6 Kbps in a radio interval, but, in an aspect of a service provider, due to a capacity problem of the radio interval, video on demand (VOD) can be assigned a transfer rate of up to 64 Kbps, and wireless Internet can be assigned a transfer rate of about 32 Kbps on average. However, in the CDMA 2000 1x EV-DO basically aiming at the packet data service, the capacity problem of the radio interval can be fully solved.

The CDMA 2000 1x EV-DO, a protocol optimized only for the high-speed packet transmission, uses a CDMA channel (1.25 MHz) that is the same frequency band as that of current CDMA One or CDMA 2000 system. Specifically, the CDMA 2000 1x EV-DO dynamically assigns a transfer rate of each subscriber in the radio interval, and maximally utilizes a proper characteristic of packet data, thereby maximizing an efficiency of use of radio interval and system.

This mobile communication technology is embodied in a different method in every country. Thus, when moving from any one country to a different country or to a mobile service provider using a different communication technology, an access terminal user should be provided with a roaming service.

Roaming refers to a service in which a mobile phone is used out of its mobile communication network of a subscription boundary in a land mobile phone service. In other words, several mobile service providers agree with each other to allow a mobile phone to move from its registered service provider's boundary to another service provider's boundary in a wireless network without service interruption or disconnection.

In several countries over the world, there are several mobile service providers, respectively. Each of them builds an independent service network. Thus, there can exist a service boundary in which a service works well or poorly depending on each service provider. In this case, it would be very convenient if the service providers agree with each other and, though the user subscribes to any enterprise, mutual service networks connect with each other to provide a good quality of service anywhere.

In the U.S., the roaming service is already provided all over the country. In Europe, if the mobile subscriber in an “A” country enters a “B” country, his/her entrance is checked by a mobile communication network of its boundary, and his/her trace is notified to a mobile communication network of a subscription boundary of the “A” country, thereby making communication possible. Even in South Korea, mobile service providers have already initiated the roaming service. Since the domestic mobile service provider has a roaming agreement with an abroad mobile service provider, an access terminal is also possible to be taken out and used abroad as it is.

However, there is not provided the roaming service based on the roaming agreement between a service provider currently providing the CDMA 2000 1x EV-DO service and another service provider, and its technological negotiation has not been made. In general, in order for the subscriber to receive a radio data service using the roaming service in the CDMA 2000 1x network, the subscriber is assigned a proper identification (ID) for roaming to the access terminal, and a packet data serving node of a visited network is set up to tunnel a packet to a packet data serving node of a home network using the proper ID of the access terminal. In this case, the roaming subscriber moving to the visited network should perform a setup using a new ID assigned from the visited network besides the ID used in the home network. Therefore, the CDMA 2000 1x network cannot support the service using the ID having ever been used in the home network.

In other words, it can occur that part of service cannot be provided. In the CDMA 2000 1x network, only a simple IP service subscriber receives the roaming service and thus does not receive a push-to-talk service and a video call service operating in a mobile IP service.

If the access terminal user roams, the visited network manages a profile commonly to the roaming access terminal user. Thus, a separate service profile, such as whether the access terminal user can use any service and can receive any QoS of service, provided in a before-roaming mobile communication network cannot be used.

Accordingly, there is a need for an improved method and system for providing roaming service in a mobile communication system.

### SUMMARY OF THE INVENTION

Exemplary embodiments of the present invention address at least the above problems and/or disadvantages and provide at least the advantages described below. It is, therefore, an object of the present invention to provide a system and method for allowing an access terminal to move from a home network to a visited network by receiving a service profile having been received from the home network, from the visited network.

It is another object of the present invention to provide a system and method for, when a subscriber receiving a data service from a CDMA 2000 1x EV-DO network moves to a CDMA 2000 1x EV-DO network of another mobile service provider, providing substantially the same data service that had been received from a home network before the service subscriber roamed.

To achieve the above and other objects, there is provided a system for providing a roaming service in a mobile communication system providing a data service to an access terminal that moves from a home network to a visited network. The exemplary system includes an access terminal for transmitting an NAI (network access identifier) to a packet data serving node of the visited network, an AAA (authentication authorization accounting) of the home network, for transmitting subscriber profile information of the access terminal to the visited network and the packet data serving node of the visited network, for determining whether or not the access terminal subscribes to the roaming service on the basis of the NAI, and, when it is determined that the access terminal subscribes to the roaming service, sending a request for transmitting the subscriber profile information of the access terminal, to the AAA of the home network, and providing at least one data service that the home network has provided to the subscriber, using the subscriber profile information.

In another exemplary aspect of the present invention, there is provided a method for providing a roaming service in a mobile communication system providing a data service to an access terminal that moves from a home network to a visited network. The method includes, in the access terminal, transmitting an NAI (network access identifier) to a packet data serving node of the visited network, in the packet data serving node of the visited network, receiving the NAI, and determining whether or not the access terminal subscribes to the roaming service, when it is determined that the access terminal subscribes to the roaming service, in the packet data serving node of the visited network, sending a request for subscriber profile information of the access terminal to an AAA (authentication authorization accounting) of the home network, in the AAA of the home network, transmitting the subscriber profile information of the access terminal to the visited network, and in the packet data serving node of the visited network receiving the subscriber profile information, providing a packet data service to the access terminal using the subscriber profile information.

In a further exemplary aspect of the present invention, there is provided a method for providing a roaming service in a mobile communication system providing a data service from a packet data serving node of a visited network to an access terminal that moves from a home network to the visited network. The method includes receiving an NAI (network access identifier) from the access terminal, determining whether or not the access terminal subscribes to the roaming service on the basis of the NAI, when it is determined that the access terminal subscribes to the roaming service, sending a request for subscriber profile information of the access terminal to an AAA (authentication authorization accounting) of the home network, receiving the subscriber profile information from the AAA of the home network, and providing the data service to the access terminal using the received subscriber profile information.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a network structure of a CDMA 2000 1x EV-DO system provided between a visited network and a home network according to an exemplary embodiment of the present invention;

FIG. 2 is a call ladder diagram illustrating a method for providing a roaming service to a simple IP service subscriber between a visited network and a home network, by an access terminal, according to an exemplary embodiment of the present invention;

FIG. 3 is a flowchart illustrating a method for providing a roaming service to a simple IP service subscriber in a PDSN of a visited network according to an exemplary embodiment of the present invention;

FIG. 4 is a call ladder diagram illustrating a method for providing a roaming service to a mobile IP service subscriber between a visited network and a home network according to an exemplary embodiment of the present invention; and

FIG. 5 is a flowchart illustrating a method for providing a roaming service to a mobile IP service subscriber in a PDSN of a visited network according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. An exemplary embodiment of the present invention will now be described in detail with reference to the annexed drawings.

An exemplary embodiment of the present invention includes an access terminal (AT) for taking charge of a CDMA 1x EV-DO radio data communication, and providing and receiving a data service, an access network for relaying subscriber data information, a packet data serving node for setting, connecting, and managing a Point-to-Point Protocol (PPP) of a subscriber to an EDGE point of a radio data service of the subscriber and an authentication authorization accounting (AAA) for managing subscriber information on authentication, authorization, and accounting. An exemplary construction of the present invention will be described in detail with reference to the accompanying drawings below.

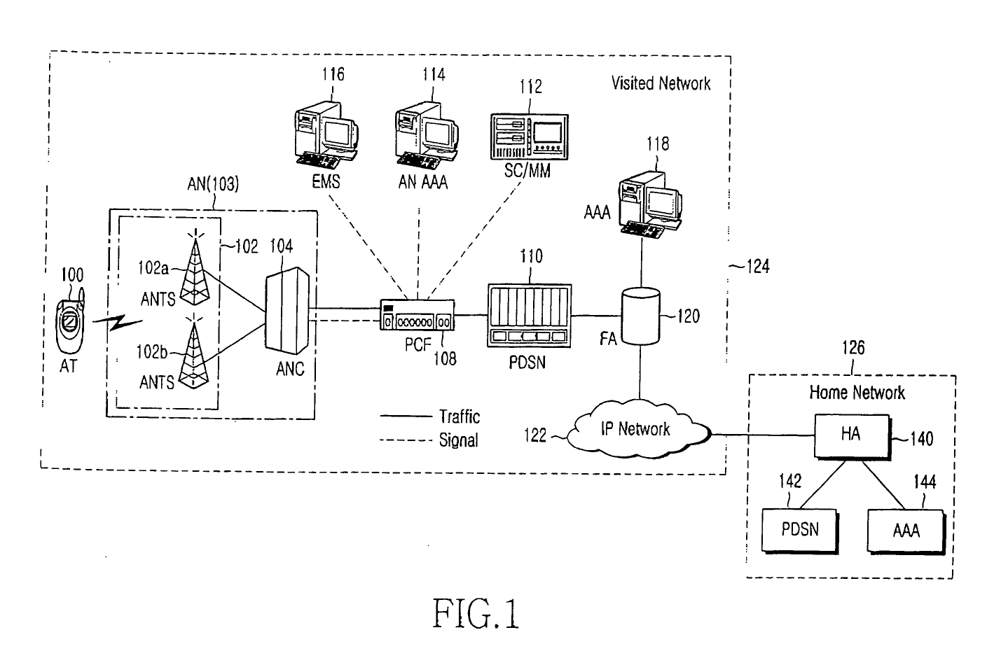

FIG. 1 illustrates a network structure of a CDMA 2000 1x EV-DO system provided between a visited network (VN) and a home network (HN) according to an exemplary embodiment of the present invention. First, prior to a description of the present invention, the HN 126 of FIG. 1 refers to a network that an access terminal 100 initially subscribes to, and the VN 124 refers to a network that the access terminal 100 newly moves to, that is, roams to and then accesses.

In FIG. 1, a FA 120 refers to a foreign agent since it manages a mobility of the access terminal 100 in the VN 124, which is an external network that the access terminal 100 roaming from the HN 126 newly accesses.

First, the visited network 124 will be described.

The access terminal 100 accesses an access network transmission system (ANTS) 102 for processing a radio link and a radio signal by an IS-856 radio access standard, which defines a packet transmission process and a signaling process for processing outgoing and incoming packet calls, and a media access control (MAC). The ANTS 102 connects with an access network controller (ANC) 104 for processing a call processing and selection function (SF), and a radio link protocol (RLP). As in FIG. 1, the ANC 104 can connect with at least two ANTS. The ANC 104 connects with a packet data serving node (PDSN) 110 of a data core network (DCN) that takes charge of authentication, IP address assignment, and routing for the access terminal 100, through a packet control function (PCF) 108.

The PCF 108 connects the ANC 104 with the PDSN 110, and takes charge of user traffic transmission between the ANC 104 and the PDSN 110. The PCF 108 can also include a session control/mobility management (SCMM) 112 for taking charge of session management, mobility management, and authentication on the access terminal 100. FIG. 1 shows that the SC/MM 112 is separated from the PCF 108.

The SC/MM 112 performs the mobility management for a CDMA 2000 1x EV-DO subscriber. The SC/MM 112 processes a request for assigning a universal access terminal identifier (UATI) of the ANC 104 for a subnet area, and transmits International Mobile Subscriber Identifier (IMSI)) and session information on the AT 100. When a request for paging to the AT 100 is generated, the SC/MM 112 performs paging depending on a position.

The PCF 108 connects with an access network (AN)-authentication authorization accounting (AAA) 114 for performing the authentication on the access terminal 100 accessing the visited network 124, an element management system (EMS) 116 for managing a system of the SC/MM 112 or the AN-AAA 114, and the PDSN 110 of the data core network.

The PDSN 110 sets, connects, and manages the PPP of the access terminal 100 to the EDGE point of the radio data service of the access terminal 100. The PDSN 110 connects with the FA 120, which manages a mobile IP session of the access terminal 100 accessing the visited network 124 to receive a mobile IP. The FA 120 connects with an IP network 122 and an AAA 118 for taking charge of authentication, authorization, and accounting for the radio data service of the subscriber.

A description of network elements (NE) shown in the HN 126 of FIG. 1 will now be made.

A PDSN 142 connects with a home agent (HA) 140 for managing the mobile IP session of the access terminal 100 accessing the VN 124 to receive a mobile IP. The HA 140 connects with the IP network 122.

The HA 144 connects with the IP network 122 and an authentication authorization accounting (AAA) 144 for taking charge of authentication, authorization, and accounting for the radio data service of the access terminal 100 subscriber.

A remarkable feature of a cellular mobile communication technology, which advances to a third generation via first and second generations that are aimed at a voice service using a circuited network shown in FIG. 1, is to provide the subscribers with a packet data service for connecting to the Internet in wide-range wireless communication environments. However, a cellular mobile communication network has a limit in supporting a high-speed packet data service, and a CDMA 2000 1x EV-DO system, a synchronous type mobile communication system, provides a data transfer rate of up to about 2.4 Mbps. In the CDMA 2000 1x EV-DO system, the ANTS 102 and the ANC 104 are called “access network (AN)”. Thus, also in the present invention, the ANTS and the ANC are called “AN” as above.

When a roaming service provider connects to another service provider network 124 out of the HN 126 in the CDMA 2000 1x EV-DO system, the access terminal 100 is assigned a UATI, which is a new sole value of the access terminal 100, from the AN 103 of another service provider network 124, and the access terminal 100 sets up a traffic tunnel with the AN 103. After that, when a roaming service subscriber of the access terminal 100 performs a radio Internet service, a radio-packet (R-P) link is set between the AN 103 and the PDSN 110. After that, the access terminal 100 and the PDSN 110 set up the PPP. At the time of setting the PPP, the access terminal 100 performs a link control protocol (LCP) process. The access terminal 100 can use simple IP or mobile IP depending on a service kind or a subscriber type. In an exemplary embodiment of the present invention, the PDSN 110 of the VN 124 determines whether or not the access terminal 100 accessing the VN 124 is a roaming service subscriber. If so, the PDSN 110 of the VN 124 sends a request for authentication on the access terminal 100 to the AAA 144 of the HN 126. The PDSN 110 also transmits subscriber information for roaming authentication, and the request and information may be sent together. In response to this, the PDSN 110 receives the subscriber information including service lists that the access terminal 100 has received from the HN 126, that is, subscriber profile information from the AAA 144 of the HN 126. Accordingly, the PDSN 110 receiving the subscriber profile information can provide services received from the HN 126, to the access terminal 100.

Thus, cases where the access terminal receives the simple IP and mobile IP services according to respective exemplary embodiments of the present invention will be described below.

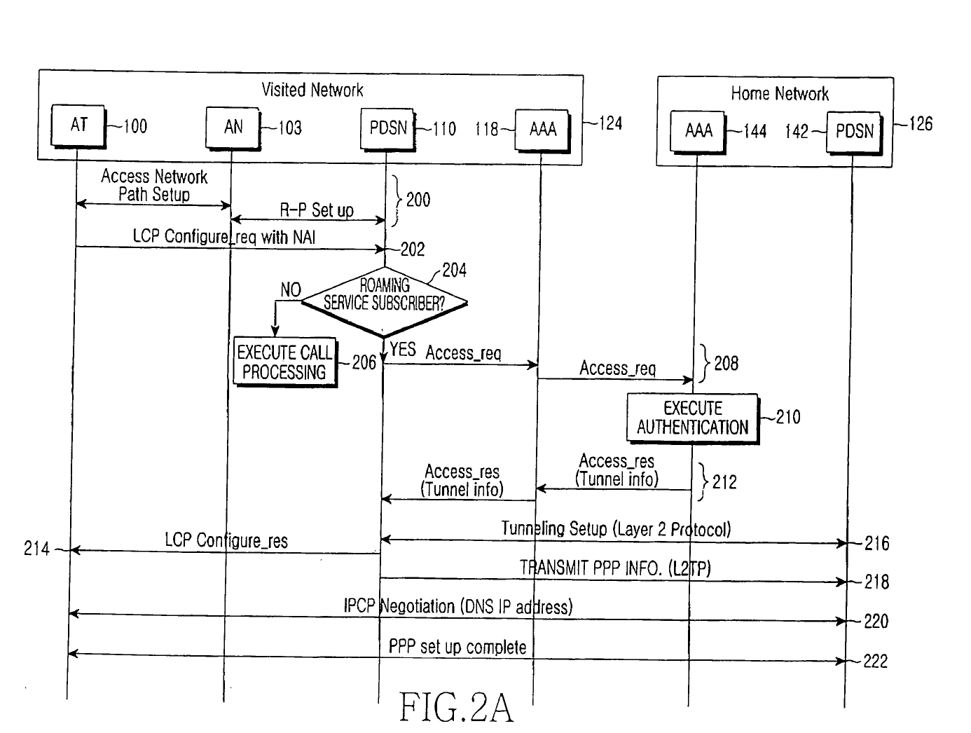

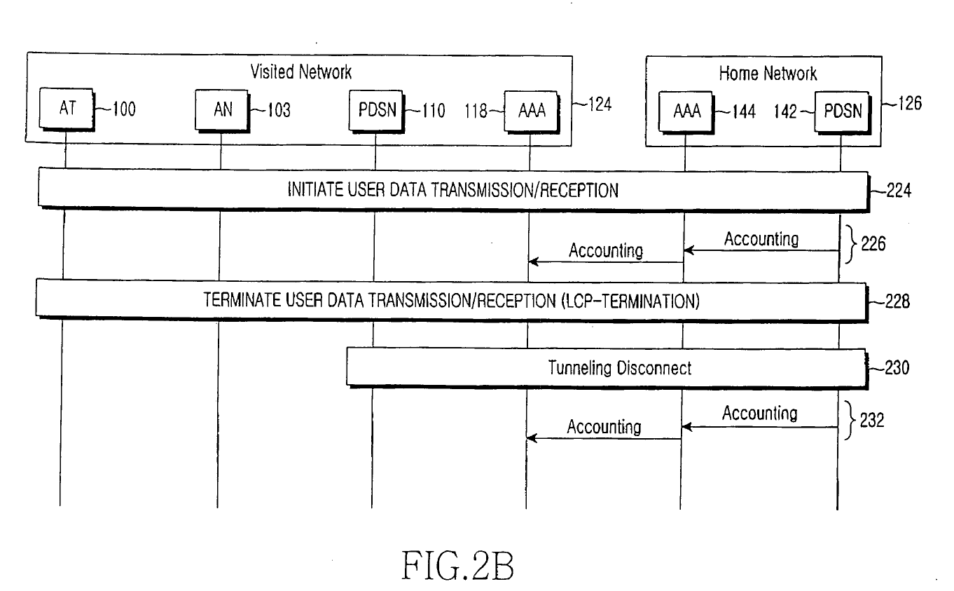

FIG. 2 is a call ladder diagram illustrating a method for providing the roaming service to a simple IP service subscriber between the visited network and the home network, by the access terminal 100, according to an exemplary embodiment of the present invention.

In Step 200, a traffic channel setup between the access terminal 100 and the AN 103 is performed, and the AN 103 performs a radio-packet (R-P) setup with the PDSN 110. In Step 202, the access terminal 100 using the simple IP service transmits an LCP configure request (LCP Configure_req) message to the PDSN 110 to configure a link control protocol (LCP).

Here, since using the simple IP service, the access terminal 100 uses challenge handshake authentication protocol (CHAP)/password authentication protocol (PAP) to configure the LCP. The access terminal 100 transmits a network access identifier (NAI) defined in a Request For Comments (RFC) 2486, which is included in a CHAP message. The NAI is of a User@Domain type. The “User”, a user identifier, is an identifier (ID) assigned from the HN 126 of the access terminal 100. The “domain”, a domain of the HN 126, can be SK Telecom or Korea Telecom Freechal (KTF), which is Korean mobile service provider of South Korea, for example.

An example of an NAI type where the user name is “jung1” and the domain is “SK Telecom” or “KTF” is shown below. It is merely exemplary that the embodiment is described on the assumption of a roaming agreement made between the Korean mobile service provider and another mobile service provider 124.

jung1@sktelecom.com

jung1@ktf.com

In Step 204, the PDSN 110 receives NAI information, separates the user name and the domain on the basis of the received NAI information, extracts the domain, and determines whether or not the access terminal 100 is a roaming service subscriber on the basis of the extracted domain. In the Step 204, in case where the visited network 124 has a domain of “china.com”, because the domain of “ktf.com” or “sktelecom.com” included in the NAI information received from the access terminal 100 accessing the visited network 124 is different from the domain of “china.com” of the visited network 124, the PDSN 110 recognizes that the access terminal 100 is a roaming service subscriber.

When it is determined in Step 204 that the access terminal 100 is not a roaming service subscriber, the PDSN 110 proceeds with Step 206 and performs call processing. The VN 124 will serve as the home network for the access terminal that is not a roaming service subscriber. When it is determined in the Step 204 that the access terminal 100 is a roaming service subscriber, the PDSN 110 proceeds with Step 208 and sends a request for authentication on the access terminal 100 to the AAA 144 of the HN 126 via the AAA 118 of the VN 124. The PDSN 110 also transmits the subscriber information for the roaming authentication, to the AAA 144 of the HN 126, and the request and information may be sent together. According to an exemplary embodiment of the present invention, the PDSN 110 of the VN 124 can send a request for the subscriber information including the service lists that the access terminal 100 has received from the HN 126, that is, the subscriber profile information, to the AAA 144 of the HN 126.

In Step 210, the AAA 144 of the HN 126 performs the authentication of the access terminal 100. Authenticating the subscriber as a normal subscriber, the AAA 144 of the HN 126 transmits an IP address of PDSN 142 of the HN 126 that is tunnel information for setting up tunneling with the PDSN 142 of the HN 126, to the PDSN 110 of the VN 124 in Step 212. Together with the tunnel information, the AAA 144 of the HN 126 transmits the subscriber profile information including the service lists that the access terminal 100 has received from the HN 126, to the AAA 118 of the VN 124. The AAA 118 of the VN 124 transmits the received subscriber profile information to the PDSN 110 of the VN 124. Thus, the AAA 118 and the PDSN 110 of the VN 124 can determine the service lists that the corresponding subscriber has received from the HN 126, and, even after roaming from the HN 126 to the VN 124, the subscriber can keep receiving a service received from the HN 126.

In Step 214, the PDSN 110 of the VN 124 sends an LCP configure response (LCP Configure_res) message to the access terminal 100. In Step 216, the PDSN 110 of the VN 124 sets up tunneling with the PDSN 142 of the HN 126 using a Layer 2 Tunneling Protocol (L2TP), a Layer 2 Forwarding Protocol (L2F), and a Virtual Tunneling Protocol (VTP). For packet data security, the tunnel information can be protected using an IP security (IPSec).

After setting up the tunneling with the PDSN 142 of the HN 126 in the Step 216, the PDSN 110 of the VN 124 transmits PPP information using the L2TP to the PDSN 142 of the HN 126 in Step 218. In Step 220, the PDSN 142 of the HN 126 performs an IP Control Protocol (IPCP) negotiation with the access terminal 100 of the VN 124 when its setup PPP information is consistent with the received PPP information. The PDSN 142 of the HN 126 again performs a PPP negotiation with the access terminal 100 of the VN 124 when its setup PPP information is not consistent with the received PPP information in the Step 218.

In the Step 220, the PDSN 142 of the HN 126 assigns a new IP to the access terminal 100 using its own IP pool. By doing so, in Step 222, the PPP setup is completed, and in Step 224, the packet data is transmitted from the access terminal 100 to the PDSN 142 of the HN 126 through the PDSN 110 of the VN 124.

In Step 226, the PDSN 142 of the HN 126 sends a request for executing the accounting for the access terminal 100 receiving the data service, to the AAA 144 of the HN 126 and the AAA 118 of the VN 124. In other words, in the Step 226 of executing the accounting for the access terminal 100, the PDSN 142 of the HN 126 sends the request for executing the accounting for the access terminal 100 accessing the VN 124 and receiving the data service, to the AAA 144 of the HN 126, and the AAA 144 of the HN 126 sends the request for executing the accounting for the access terminal 100, to the AAA 118 of the VN 124.

If user data transmission is terminated between the access terminal 100 and the PDSN 142 of the HN 126 in Step 228, the tunneling between the PDSN 110 of the VN 124 and the PDSN 142 of the HN 126 is disconnected in Step 230. In Step 232, since the data service of the access terminal 100 is terminated, the PDSN 142 of the HN 126 sends a request for terminating the accounting for the access terminal 100, to the AAA 144 of the HN 126 and the AAA 118 of the VN 124.

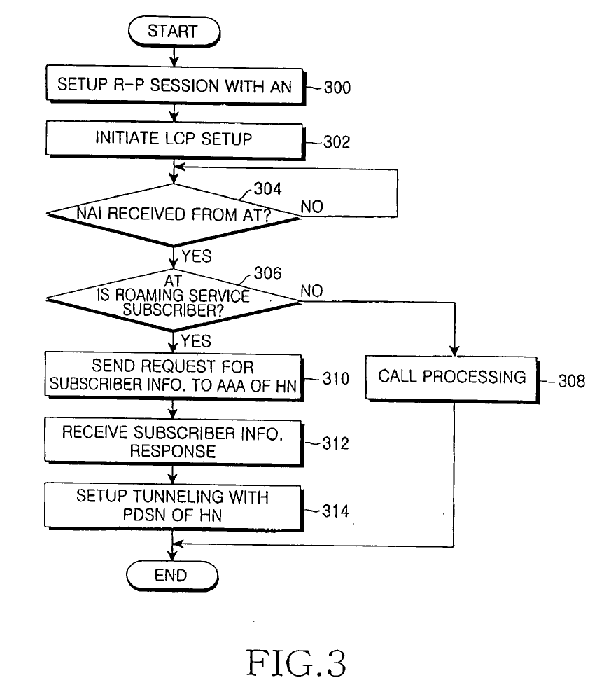

FIG. 3 is a flowchart illustrating a method for providing roaming service to the simple IP service subscriber in the PDSN 110 of the visited network 124 according to an exemplary embodiment of the present invention.

The PDSN 110 sets up an R-P session with the AN 103 in Step 300, and initiates the LCP session setup with the access terminal 100 in Step 302.

In Step 304, the PDSN 110 determines whether or not it receives the NAI from the access terminal 100 when initiating the LCP setup with the access terminal 100. Upon the receipt of the NAI in the Step 304, the PDSN 110 determines whether or not the access terminal 100 is the roaming service subscriber on the basis of the NAI received from the access terminal 100 in Step 306: The NAI information received from the access terminal 100 can be separated as the user name and the domain, and it can be recognized whether or not the access terminal 100 is the roaming service subscriber on the basis of the domain. Its detailed description is the same as that of the Step 202 of FIG. 2. Determining that the access terminal 100 is not the roaming service subscriber in the Step 306, the PDSN 110 proceeds with Step 308 and performs call processing.

On the contrary, determining that the access terminal 100 is a roaming service subscriber in the Step 306, the PDSN 110 proceeds with Step 310 and sends a request for authentication of the access terminal 100 to the AAA 144 of the HN 126. The PDSN 110 also sends a request for the subscriber profile information on the access terminal 100, together. In Step 312, the PDSN 110 receives a response to the request for authentication on the access terminal 100 in the Step 310, from the AAA 144 of the HN 126. The PDSN 110 also receives the subscriber profile information on the access terminal 100, together with the response to the request for the authentication, from the AAA 144 of the HN 126. Transmitting the subscriber profile information in the Step 312, the AAA 144 of the HN 126 also transmits the tunnel information for allowing the PDSN 110 of the VN 124 to set up the tunneling with the PDSN 142 of the HN 126, together.

In Step 314, the PDSN 110 sets up the tunneling with the PDSN 142 of the HN 126 on the basis of the tunnel information received in the Step 312.

As shown in FIGS. 2 and 3, even when accessing the VN 124, the access terminal 100 can receive the service received from the HN 126, from the VN 124 according to an exemplary embodiment of the present invention.

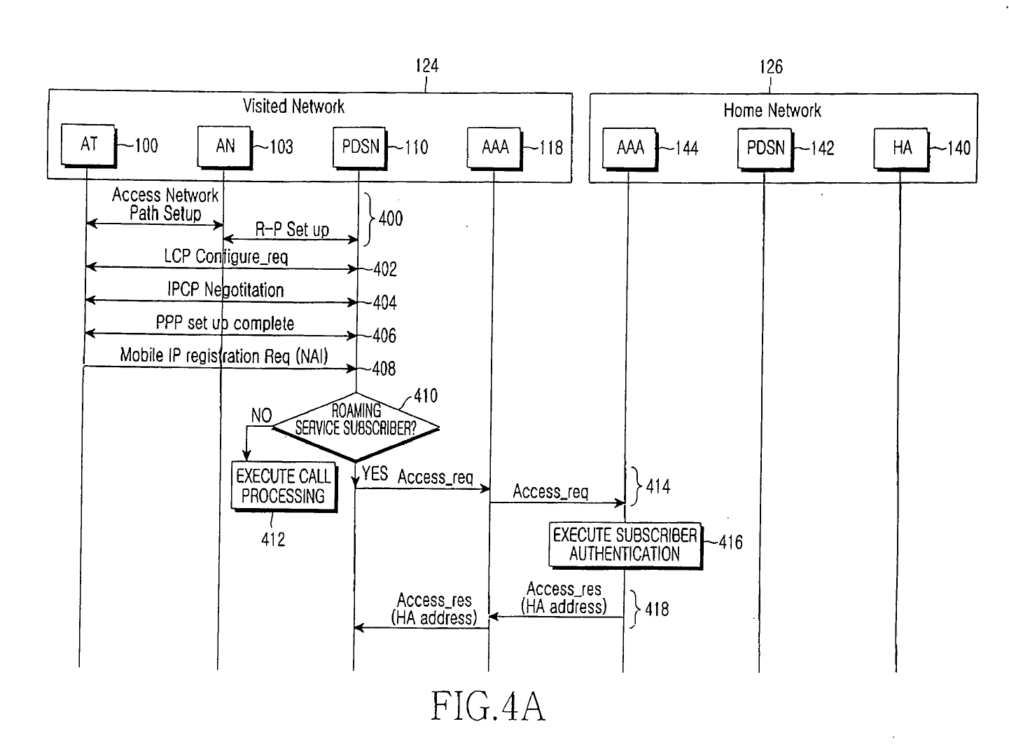

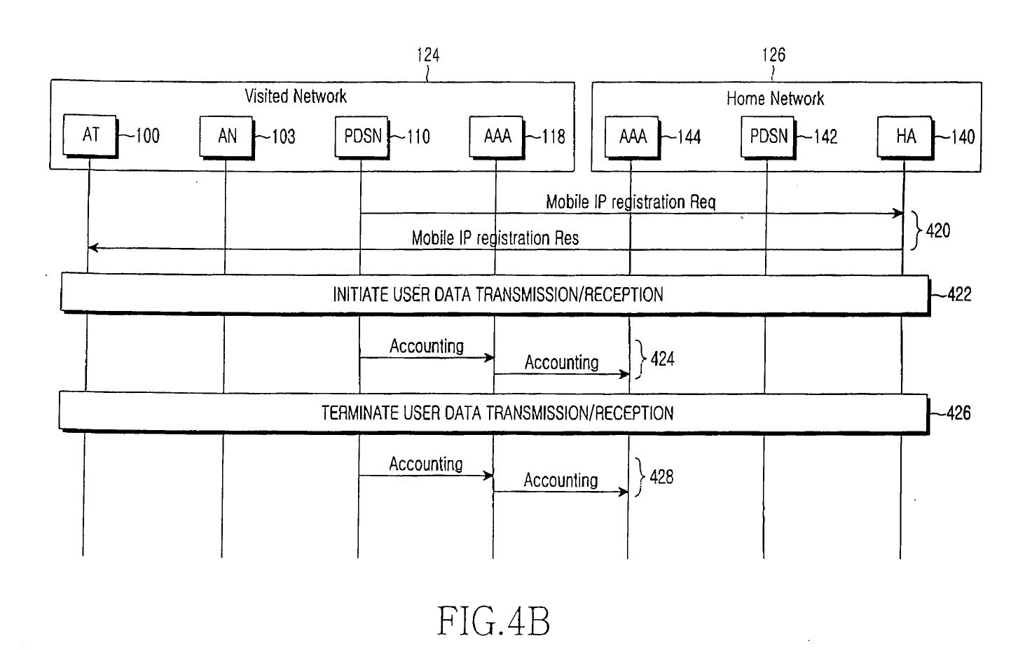

FIG. 4 is a call ladder diagram illustrating a method for providing a roaming service to the mobile IP service subscriber between the visited network 124 and the home network 126 according to an exemplary embodiment of the present invention.

In Step 400, a traffic channel setup between the access terminal 100 and the AN 103 is performed, and the AN 103 performs a radio-packet (R-P) setup with the PDSN 110. In Step 402, the access terminal 100 using the mobile IP service sends an LCP configure request (LCP Configure_req) message to the PDSN 110 to configure a link control protocol (LCP). In Step 404, the PDSN 110 performs an IP control protocol (IPCP) negotiation with the access terminal 100 of the VN 124. In Step 406, the PDSN 110 completes PPP setup with the access terminal 100.

However, when using the mobile IP service, the subscriber of the access terminal 100 does not use CHAP/PAP in the Step 402 of configuring the LCP. Therefore, the PDSN 110 cannot recognize the subscriber information on the access terminal 100. Thus, after completing the PPP setup of the PDSN 110 of the VN 124 in the Step 406, the access terminal 100 transmits a mobile IP registration request message defined in a Request For Comments (RFC) 2002, to the PDSN 110 in Step 408.

In Step 410, the PDSN 110 receives the mobile IP registration request message from the access terminal 100, and determines whether or not the access terminal 100 is a roaming service subscriber. In a method for determining whether or not the access terminal 100 is a roaming service subscriber in the Step 410, the PDSN 110 separates the user name and the domain from the NAI information of an extension field of the NAI within the mobile IP registration request message, that is, from the user@domain information. After that, the PDSN 110 determines on the basis of the domain whether or not the access terminal 100 is a roaming service subscriber. Determining that the access terminal 100 is not a roaming service subscriber in the Step 410, the PDSN 110 proceeds with Step 412 and performs a mobile IP execution process.

On the contrary, determining that the subscriber of the access terminal 100 is a roaming service subscriber, the PDSN 110 proceeds with Step 414 and sends a request for authentication on the access terminal 100, to the AAA 144 of the HN 126. The PDSN 110 also transmits the subscriber information for the roaming authentication to the AAA 144 of the HN 126, and the request and information may be sent together. According to an exemplary embodiment of the present invention, the PDSN 110 of the VN 124 can send a request for the subscriber information including the service lists that the access terminal 100 has received from the HN 126, that is, the subscriber profile information to the AAA 144 of the HN 126.

In Step 416, the AAA 144 of the HN 126 performs the subscriber authentication of the access terminal 100. Authenticating the subscriber as a normal subscriber, in Step 418, the AAA 144 of the HN 126 transmits an IP address of the HA 140 of the HN 126, which is the tunnel information for setting up tunneling with the HA 140 of the HN 126, to the PDSN 110 of the VN 124. Together with the tunnel information, the AAA 144 of the HN 126 transmits the subscriber profile information including the service lists that the access terminal 100 has received from the HN 126, to the AAA 110 of the VN 124. The AAA 118 of the VN 124 transmits the received subscriber profile information to the PDSN 110 of the VN 124. Thus, the PDSN 110 and the AAA 118 of the VN 124 can determine the service list that the subscriber has received from the HN 126, and, even after roaming from the HN 126 to the VN 124, the subscriber can keep receiving a service received from the HN 126.

In Step 420, the PDSN 110 of the VN 124 sets up a mobile IP session using new information of the HA 140 received from the AAA 144 of the HN 126. In other words, in the Step 420, the PDSN 110 of the VN 124 transmits a mobile IP registration request message for the access terminal 100, to the HA 140 of the HN 126. The HA 140 of the HN 126 responds to the mobile IP registration request message. The HA 140 dynamically assigns a new IP address to the access terminal 100, or transmits a message of determining the access terminal's IP address received from the access terminal 100, to the access terminal 100.

When the mobile IP session between the access terminal 100 and the PDSN 142 of the HN 126 is set up in the Step 420, in Step 422, the access terminal 100 communicates the data packet with the PDSN 110 of the VN 124 using the mobile IP session. The PDSN 110 of the VN 124 and the HA 140 of the HN 126 transmit the data packet using the IP Security (IPSec) protocol, thereby allowing the access terminal 100 to receive the data service.

In Step 424, the PDSN 110 of the VN 124 sends a request for initiating the accounting, to the AAA 118 of the VN 124 and the AAA 144 of the HN 126. In Step 426, user data communication is terminated. If so, the PDSN 110 of the VN 124 sends a request for terminating the accounting to the AAA 118 of the VN 124 and the AAA 144 of the HN 126 in step 428. A process of sending the request for the accounting initiation in the Step 424 includes steps of sending the request for the accounting initiation to the AAA 118 of the VN 124 from the PDSN 110, and sending the request for the accounting initiation to the AAA 144 of the HN 126 from the AAA 118 of the VN 124. The process of sending the request the accounting termination includes steps of sending the request for the accounting termination to the AAA 118 of the VN 124 from the PDSN 110, and sending the request for the accounting termination to the AAA 144 of the HN 126 from the AAA 118 of the VN 124.

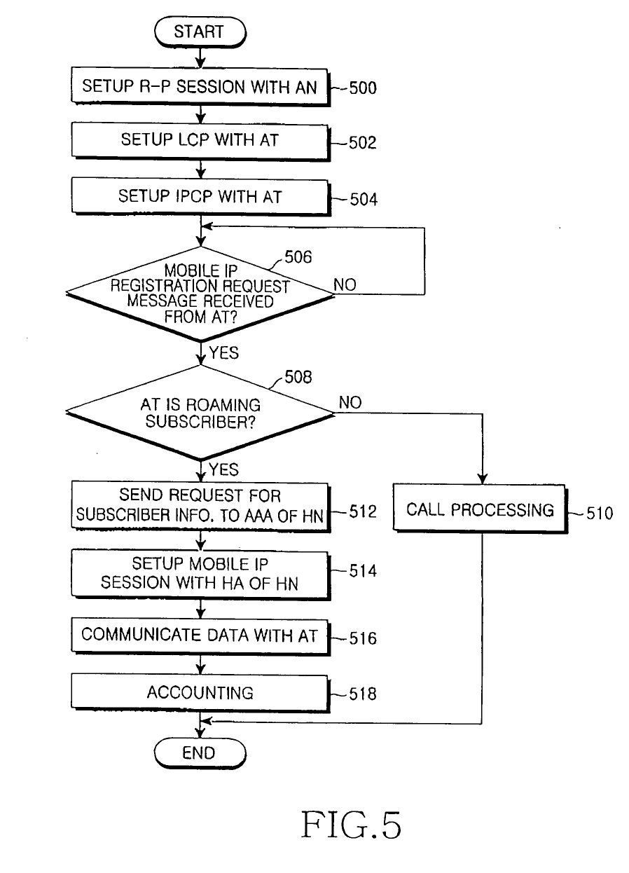

FIG. 5 is a flowchart illustrating a method for providing the roaming service to a mobile IP service subscriber in the PDSN 110 of the visited network 124 according to an exemplary embodiment of the present invention.

The PDSN 110 of the VN 124 sets up an R-P session with the AN 103 in Step 500, and sets up an LCP session with the access terminal 100 in Step 502. In Step 504, the PDSN 110 sets up an IPCP with the access terminal 100, thereby completing PPP setup.

In Step 506, the PDSN 110 determines whether or not it receives a mobile IP registration request message from the access terminal 100. Upon the receipt of the mobile IP registration request message, the PDSN 110 proceeds with Step 508 and determines whether or not the access terminal 100 is a roaming service subscriber. Determining that the access terminal 100 is not a roaming service subscriber in the Step 508, the PDSN 110 proceeds with Step 510 and performs call processing.

On the contrary, if it is determined that the access terminal 100 is a roaming service subscriber in the Step 508, the PDSN 110 proceeds with Step 512 and sends the request for the authentication of the access terminal 100, to the AAA 144 of the HN 126. The PDSN 110 also sends a request for the subscriber profile information on the mobile terminal 100, and the request and information may be sent together. Together with the subscriber profile information, the PDSN 110 receives the IP address of the HA 140 from the AAA 144 of the HA 126. In Step 514, the PDSN 110 sets up the mobile IP session with the HA 140 of the HN 126. The PDSN 110 performs a data communication with the mobile terminal 100 and the HA 140 of the HN 126 using the IPSec in Step 516, and sends a request for initiating the accounting to the AAA 118 of the VN 124 and the AAA 144 of the HN 126 in Step 518.

Only roaming between the CDMA 2000 1x EV-DO systems is described according to an exemplary embodiment of the present invention, but the present invention is applicable between the CDMA 2000 1x and CDMA 2000 1x systems and the CDMA 2000 1x and CDMA 2000 1x EV-DO systems.

Intending to receive the radio data service from the existing home network though moving to another service provider's network area, the CDMA mobile communication subscriber can receive the radio data service from the home network, using existing information without user's change as it is. Even when connecting to another service provider network, the access terminal subscriber can transmit information on the accounting to the home network, thereby receiving an integral accounting detail.

Further, though roaming from the home network to the visited network, the roaming service subscriber can use a service profile in the home network, even in the visited network, as it is.

While the invention has been shown and described with reference to a certain embodiments thereof, it will be understood by those skilled in the art that various changes in form and details may be made therein without departing from the spirit and scope of the invention as defined by the appended claims and the full scope of equivalents thereof.

What is claimed is:

1. A system for providing a roaming service in a mobile communication system, the system comprising:
a packet data serving node of a visited network;
an access terminal, for transmitting an NAI (network access identifier) to the packet data serving node of the visited network;
an AAA (authentication authorization accounting) of a home network, for transmitting subscriber profile information of the access terminal to the visited network;
wherein the packet data serving node of the visited network determines whether or not the access terminal subscribes to the roaming service on the basis of the NAI, and, when it is determined that the access terminal subscribes to the roaming service, sends a request for transmitting the subscriber profile information of the access terminal to the AAA of the home network, and provides at least one data service that the home network has provided to the subscriber, using the subscriber profile information.

2. The system of claim 1, wherein the packet data serving node of the visited network receives the NAI from the access terminal, separates a user name and a domain from the received NAI, and determines whether or not the access terminal subscribes to the roaming service using the separated domain.

3. The system of claim 1, wherein the AAA of the home network transmits tunnel information to the packet data serving node of the visited network.

4. The system of claim 3, wherein the tunnel information comprises an Internet protocol (IP) address of a packet data serving node of the home network for allowing the packet data serving node of the visited network to perform tunneling.

5. The system of claim 3, wherein the tunnel information comprises an IP address of a home agent of the home network for allowing the packet data serving node of the visited network to perform tunneling.

6. The system of claim 4, wherein the packet data serving node of the visited network initiates tunneling with the packet data serving node of the home network, using the tunnel information, and provides a packet data service to the access terminal.

7. The system of claim 5, wherein the packet data serving node of the visited network initiates tunneling with the home agent of the home network, using the tunnel information, and provides a packet data service to the access terminal.

8. The system of claim 6, wherein, upon initiation of packet data service to the access terminal, the packet data serving node of the home network sends a request for accounting initiation to the AAA of the home network and an AAA of the visited network.

9. The system of claim 7, wherein, upon initiation the packet data service to the access terminal, the packet data serving node of the visited network sends a request for accounting initiation to an AAA of the visited network and the AAA of the home network.

10. A method for providing a roaming service in a mobile communication system, the method comprising:
transmitting, by an access terminal, an NAI (network access identifier) to a packet data serving node of a visited network;
receiving, in the packet data serving node of the visited network, the NAI;
determining, by the packet data serving node of the visited network, whether or not the access terminal subscribes to a roaming service;
sending, by the packet data serving node of the visited network, a request for subscriber profile information of the access terminal to an AAA (authentication authorization accounting) of the home network when it is determined that the access terminal subscribes to the roaming service;
transmitting, by the AAA of the home network, the subscriber profile information of the access terminal to the visited network; and
providing, by the packet data serving node of the visited network receiving the subscriber profile information, a packet data service to the access terminal using the subscriber profile information.

11. The method of claim 10, wherein, determining, by the packet data serving node of the visited network, whether or not the access terminal subscribes to the roaming service on the basis of the NAI, comprises:
receiving the NAI from the access terminal;
separating a user name and a domain from the received NAI; and
determining whether or not the access terminal subscribes to the roaming service using the separated domain.

12. The method of claim 11, further comprising transmitting, by the AAA of the home network, tunnel information to the packet data serving node of the visited network.

13. The method of claim 12, wherein the tunnel information comprises an Internet protocol (IP) address of a packet data serving node of the home network for allowing the packet data serving node of the visited network to perform tunneling.

14. The method of claim 12, wherein the tunnel information comprises an IP address of a home agent of the home network for allowing the packet data serving node of the visited network to perform tunneling.

15. The method of claim 13, further comprising initiating tunneling in the packet data serving node of the visited network with the packet data serving node of the home network, using the tunnel information.

16. The method of claim 14, further comprising initiating tunneling in the packet data serving node of the visited network with the home agent of the home network, using the tunnel information.

17. The method of claim 15, further comprising sending, by the packet data serving node of the home network, a request for accounting initiation to the AAA of the home network and an AAA of the visited network upon initiation of packet data service to the access terminal.

18. The method of claim 16, further comprising sending, by the packet data serving node of the home network, a request for accounting initiation to an AAA of the visited network and the AAA of the home network upon initiation of packet data service to the access terminal.

19. A method for providing a roaming service in a mobile communication system, the method comprising:
receiving, by a packet data serving node of a visited network, an NAI (network access identifier) from an access terminal;
determining, on the basis of the received NAI, whether or not the access terminal subscribes to a roaming service;
sending a request for subscriber profile information of the access terminal to an AAA (authentication authorization accounting) of the home network when it is determined that the access terminal subscribes to the roaming service;
receiving the subscriber profile information from the AAA of the home network; and
providing a data service to the access terminal using the received subscriber profile information.

20. The method of claim 19, further comprising receiving, by the packet data serving node of the visited network, tunnel information from the AAA of the home network.

21. The method of claim 20, wherein the tunnel information comprises an Internet protocol (IP) address of a packet data serving node of the home network for allowing the packet data serving node of the visited network to perform tunneling.

22. The method of claim 20, wherein the tunnel information comprises an IP address of a home agent of the home network for allowing the packet data serving node of the visited network to perform tunneling.

23. The method of claim 21, further comprising initiating tunneling in the packet data serving node of the visited network with the packet data serving node of the home network, using the tunnel information.

24. The method of claim 22, further comprising initiating tunneling in the packet data serving node of the visited network with the home agent of the home network, using the tunnel information.

25. The method of claim 23, further comprising sending, by the packet data serving node of the home network, a request for accounting initiation to the AAA of the home network and an AAA of the visited network upon initiation of packet data service to the access terminal.

26. The method of claim 24, further comprising sending, by the packet data serving node of the visited network, a request for accounting initiation to an AAA of the visited network and the AAA of the home network upon initiation of packet data service to the access terminal.

27. The method of claim 19, wherein determining, on the basis of the NAI, whether or not the access terminal subscribes to the roaming service, comprises:
receiving the NAI from the access terminal;
separating a user name and a domain from the received NAI; and
determining whether or not the access terminal subscribes to the roaming service using the separated domain.

28. A method of operating a packet data serving node (PDSN) to allow a roaming service in a mobile communication system that provides a data service to an access terminal that moves from a home network to a visited network, the method comprising:
receiving an NAI (network access identifier) from an access terminal at a PDSN of the visited network;
determining, at the PDSN of the visited network, whether or not the access terminal subscribes to the roaming service on the basis of the NAI;
sending a request from the PDSN of the visited network for transmitting the subscriber profile information of the access terminal to the authentication authorization accounting (AAA) of a home network when it is determined that the access terminal subscribes to the roaming service, the AAA transmitting subscriber profile information of the access terminal to the visited network; and
providing, by the PDSN of the visited network, at least one data service that the home network has provided to the subscriber using the subscriber profile information.

29. The method of claim 28, further comprising:
separating a user name and a domain from the received NAI; and
determining whether or not the access terminal subscribes to the roaming service using the separated domain.

30. The method of claim 28, wherein the AAA of the home network transmits tunnel information to the PDSN of the visited network, the tunnel information comprises an Internet protocol (IP) address of a packet data serving node of the home network for allowing the PDSN of the visited network to perform tunneling and an IP address of a home agent of the home network for allowing the packet data serving node of the visited network to perform tunneling, the method further comprising:
initiating tunneling with a PDSN of the home network by the PDSN of the visited network using the tunnel information; and
providing a packet data service to the access terminal.

31. The method of claim 30, further comprising:
initiating tunneling with the home agent of the home network by the PDSN of the visited network;
using the tunnel information; and
providing a packet data service to the access terminal.

32. The method of claim 31, further comprising sending a request for accounting initiation to the AAA of the home network and an AAA of the visited network by the PDSN of the home network upon initiation of packet data service to the access terminal.

33. The method of claim 32, further comprising sending a request for accounting initiation to an AAA of the visited network and the AAA of the home network from the PDSN of the visited network upon initiation the packet data service to the access terminal.

34. A system for operating a packet data serving node (PDSN) to allow a roaming service in a mobile communication system that provides a data service to an access terminal that moves from a home network to a visited network, the system comprising:
means for receiving an NAI (network access identifier) from an access terminal;
means for determining whether or not the access terminal subscribes to the roaming service on the basis of the NAI;
means for sending a request for transmitting the subscriber profile information of the access terminal to the authentication authorization accounting (AAA) of a home network when it is determined that the access terminal subscribes to the roaming service, the AAA transmitting subscriber profile information of the access terminal to the visited network; and
means for providing at least one data service that the home network has provided to the subscriber using the subscriber profile information.

35. The system of claim 34, further comprising:
means for separating a user name and a domain from the received NAI; and
means for determining whether or not the access terminal subscribes to the roaming service using the separated domain.
